(19) United States
(12) Patent Application Publication
(10) Pub. No.: US 2008/0226897 A1
(43) Pub. Date: Sep. 18, 2008

(54) Cubic Boron Nitride Compacts

(76) Inventors: Nedret Can, Boksburg (ZA); Richard Bodkin, Johannesburg (ZA)

Correspondence Address: FROMMER LAWRENCE & HAUG, 745 FIFTH AVENUE- 10TH FL., NEW YORK, NY, 10151, US

(21) Appl. No.: 11/911,744

(22) PCT Filed: Apr. 24, 2006
(86) PCT No.: PCT/IB06/00981

§ 371 Date: May 2, 2008

(30) Foreign Application Priority Data
Apr. 26, 2005 (ZA) 2005/03368

(51) Int. Cl. C04B 35/5835; B32B 5/02

(52) U.S. Cl. 428/325; 501/96.4

(57) ABSTRACT

The cubic boron nitride compact contains a secondary hard phase, which comprises at least one aluminium magnesium boride compound, such as AlMgB₁₄. The aluminium magnesium boride present in the secondary hard phase may consist of AlMgB₁₄ only or a mixture of AlMgB₁₄ and one or more other aluminium magnesium boride compounds. The aluminium magnesium boride compound or compounds may also be doped with elements such as silicon, titanium, molybdenum, tungsten, nickel and iron, or borides, carbides and nitrides thereof.

### BACKGROUND OF THE INVENTION

This invention relates to cubic boron nitride compacts.

Boron nitride exists typically in three crystalline forms, namely cubic boron nitride (cBN), hexagonal boron nitride (hBN) and wurtzitic cubic boron nitride (wBN). Cubic boron nitride is a hard zinc-blende form of boron nitride that has a similar structure to that of diamond. In the cBN structure, the bonds that form between the atoms are strong, mainly covalent tetrahedral bonds. Methods for preparing cBN are well known in the art. One such method is subjecting hBN to very high pressures and temperatures, in the presence of a specific catalytic additive material, which may include the alkali metals, alkaline earth metals, lead, tin and nitrides of these metals. When the temperature and pressure are decreased, cBN may be recovered.

cBN has wide commercial application in machining tools and the like. It may be used as an abrasive particle in grinding wheels, cutting tools and the like or bonded to a tool body to form a tool insert using conventional electroplating techniques.

cBN may also be used in a bonded form as a cBN compact, also known as PCBN. cBN compacts tend to have good abrasive and chemical wear resistance, are thermally stable, have a high thermal conductivity, good impact resistance and have a low coefficient of friction when in contact with a workpiece.

Diamond is the only material that is harder than cBN. However, as diamond tends to react with certain materials such as iron, it cannot be used when working with iron containing metals and therefore use of cBN in these instances is preferable.

cBN compacts comprise sintered polycrystalline masses of cBN particles. The cBN content is high. When the cBN content exceeds 80 percent by volume of the compact, there is a considerable amount of direct cBN-to-cBN contact and physical bonding. When the cBN content is lower, e.g. in the region of 40 to 60 percent by volume of the compact, then the extent of direct cBN-to-cBN contact and physical bonding is less.

cBN compacts will generally also contain a bonding phase which is typically a cBN catalyst or contain such a catalyst. Suitable bonding phases contain elements such as aluminium, iron, cobalt, nickel, tungsten, silicon, titanium, combinations of these metals their nitrides, carbides and carbonitrides.

When the cBN content of the compact is less than 60 percent by volume there is generally present another hard phase, which may be ceramic in nature. Examples of suitable ceramic hard phases are carbides, nitrides, borides and carbonitrides of Group 4, 5 or 6 transition metals and aluminium oxide, and mixtures thereof.

cBN compacts may be bonded directly to a tool body, in the formation of a tool insert or tool. However, for many applications it is preferable that the compact is bonded to a substrate/support material, forming a supported compact structure, and then the supported compact structure is bonded to a tool body. The substrate/support material is typically a cemented metal carbide that is bonded together with a binder such as cobalt, nickel, iron or a mixture or alloy thereof. The metal carbide particles may comprise tungsten, titanium or tantalum carbide particles or a mixture thereof.

A known method for manufacturing the polycrystalline cBN compacts and supported compact structures involves subjecting an unsintered mass of cBN particles, to high temperature and high pressure conditions, i.e. conditions at which the cBN is crystallographically stable, for a suitable time period. A catalyst or catalyst-containing phase may be used to enhance the bonding of the particles. Typical conditions of high temperature and pressure which are used are temperatures in the region of about 1300° C. or higher and pressures of about 2 GPa or higher. The time period for maintaining these conditions is typically about 3 to 120 minutes.

The sintered cBN compact, with or without a substrate, is often cut into the desired size and/or shape of the particular cutting or drilling tool to be used and then mounted on to a tool body utilising brazing techniques.

During the high speed machining of a range of ferrous materials, notably hardened steels and ductile and compacted-graphite cast irons, tool life of cubic boron nitride compacts is limited by tribochemical wear. This problem is exacerbated by the higher cutting speeds demanded in applications.

### SUMMARY OF THE INVENTION

According to the present invention, a cubic boron nitride compact (PCBN) comprises a mass of cubic boron nitride particles and a secondary hard phase, which includes at least one aluminium magnesium boride compound.

According to another aspect of the invention, there is provided the use of a cubic boron nitride compact as described above in the machining, preferably the high speed machining, of a ferrous material.

### DESCRIPTION OF EMBODIMENTS

The cubic boron nitride compact of the invention contains a secondary hard phase, which comprises at least one aluminium magnesium boride compound. The aluminium magnesium boride compound, as it is known in the art, comes in various forms. A very hard aluminium magnesium boride compound, clearly identified and characterised in the art, is Al_{0.75}Mg_{0.78}B₁₄, referred to as AlMgB₁₄. The aluminium magnesium boride present in the secondary hard phase may consist of AlMgB₁₄ only or a mixture of AlMgB₁₄ and one or more other aluminium magnesium boride compounds. Furthermore, the aluminium magnesium boride compound or compounds may be doped with elements such as silicon, titanium, molybdenum, tungsten, nickel and iron, or borides, carbides and nitrides thereof. Such dopants have the effect of altering the properties such as hardness and wear resistance of the aluminium magnesium boride. The dopant element may also form a complex compound with the aluminium magnesium boride, typically AlMgB₁₄:X where X represents the element.

The secondary hard phase may consist of the at least one aluminium magnesium boride compound, in particular AlMgB₁₄, with any other elements being in trace or minor quantities only.

The secondary hard phase may also comprise the at least one aluminium magnesium boride compound, in particular AlMgB₁₄, and one or more other hard phases e.g. titanium carbide.

The cubic boron nitride compact may also contain a binder phase known in the art. Suitable binder phases contain elements such as B, Al, Si, Fe, Co, Ni, Ti, W and the like.

The content of the cubic boron nitride in the compact will vary according to the nature or type of compact desired and will typically be in the range 30 to 90 percent by volume. The cubic boron nitride content can be high, i.e. at least 80 percent by volume. Alternatively, the cubic boron nitride content may be lower, for example, in the range 40 to 60 percent by volume.

The particle size of the cubic boron nitride will generally be larger than that of the aluminium magnesium boride. Typically, the particle size of the cubic boron nitride will be in the range 0.1 micron to 50 micron and the particle size of the aluminium magnesium boride compound will be in the range 0.01 micron up to 20 micron.

The cubic boron nitride compact of the invention may be made by subjecting a mixture of cubic boron nitride particles, aluminium magnesium boride particles and any other secondary hard phase particles, and binder phase particles, when used, to elevated temperature and pressure conditions at which cubic boron nitride is crystallographically stable for a suitable period of time. As mentioned above, such conditions are well known in the art. The aluminium magnesium boride compounds may be used as such in the starting mixture. Alternatively, a source of aluminium and magnesium may be mixed with the cubic boron nitride and the aluminium magnesium boride produced during the pre-treatment stage, for example by providing a mixture of aluminium, magnesium and boron powders, with the cubic boron nitride particles, and heating them under appropriate temperature and pressure conditions.

The cubic boron nitride compact of the invention has excellent wear resistance and hardness, particularly under elevated temperature conditions experienced in the high speed machining of ferrous materials, notably hardened steels and ductile and compact-graphite cast irons.

The invention will now be described by in more detail by way of the following non-limiting example.

### EXAMPLE

AlMgB14, 20-40 percent by volume particle size (5-15 microns particle size) was added to cBN powders (0.5-5 microns particle size) and milled in a planetary mill for 2 hours in methanol. The powders were dried and pressed to form a green state, essentially unbonded mass. The mass was subjected to a pressure of 5.5 GPa and a temperature of 1300° C. to form a cBN-AlMgB₁₄, composite material (PCBN). XRD traces confirmed the presence of AlMgB₁₄, post ultra high temperature/pressure treatment. Two such compacts were produced, the one containing 60 percent by volume cBN and the other 80 percent by volume cBN.

1. A cubic boron nitride compact comprising a mass of cubic boron nitride particles and a secondary hard phase, which includes at least one aluminium magnesium boride compound.

2. A cubic boron nitride compact according to claim 1 wherein the secondary hard phase consists of AIMgB₁₄,

3. A cubic boron nitride compact according to claim 1 wherein the secondary hard phase consists of a mixture of AIMgB₁₄, and one or more other aluminium magnesium boride compounds.

4. A cubic boron nitride compact according to claim 1 wherein the secondary hard phase contains one or more hard phases in addition to the aluminium magnesium boride.

5. A cubic boron nitride compact according to claim 1 which includes a binder phase.

6. A cubic boron nitride compact according to claim 5 wherein the binder phase contains an element selected from boron, aluminium, silicon, iron, cobalt, nickel, titanium, tungsten and the like.

7. A cubic boron nitride compact according to claim 1 wherein the aluminium magnesium boride is AIMgB₁₄.

8. A cubic boron nitride compact according to claim 1 wherein the aluminium magnesium boride is a mixture of AIMgB₁₄ and one or more other aluminium magnesium boride compounds.

9. A cubic boron nitride compact according to claim 1 wherein the cubic boron nitride content is in the range 30 to 90 percent by volume.

10. A cubic boron nitride compact according to claim 1 wherein the particle size of the cubic boron nitride is in the range 0.1 to 50 microns.

11. A cubic boron nitride compact according to claim 1 wherein the particle size of the aluminium magnesium boride is in the range 0.01 to 20 microns.

12. A cubic boron nitride compact according to claim 1 substantially as herein described with reference to the illustrative example.

13. Use of a cubic boron nitride compact according to claim 1 in the machining of a ferrous material.

14. Use according to claim 13 wherein the machining is high speed machining
